(19) United States
(12) Patent Application Publication
(10) Pub. No.: US 2005/0268989 A1
(43) Pub. Date: Dec. 8, 2005

(54) R-t-b sintered magnet and process for producing the same

(76) Inventors: Hiroyuki Tomizawa, Osaka (JP); Yutaka Matsuura, Osaka (JP)

Correspondence Address: NIXON PEABODY, LLP, 401 9TH STREET, NW, SUITE 900, WASHINGTON, DC, 20004-2128, US

(21) Appl. No.: 10/527,797

(22) PCT Filed: Mar. 10, 2004
(86) PCT No.: PCT/JP04/03150

§ 371 Date: Mar. 15, 2005

(51) Int. Cl. H01F 1/14

(52) U.S. Cl. 148/105; 148/302

(57) ABSTRACT

An R-T-B based sintered magnet with a reduced B concentration but with sufficiently high coercivity is provided. An R-T-B based sintered magnet according to the present invention has a composition including: 27.0 mass % to 32.0 mass % of R, which is at least one of Nd, Pr, Dy and Tb and which always includes either Nd or Pr; 63.0 mass % to 72.5 mass % of T, which always includes Fe and up to 50% of which is replaceable with Co; 0.01 mass % to 0.08 mass % of Ga; and 0.85 mass % to 0.98 mass % of B.

### TECHNICAL FIELD

The present invention relates to an R-T-B based sintered magnet and a method for producing the same.

### BACKGROUND ART

An R-T-B based permanent magnet, one of outstanding high-performance permanent magnets, has such excellent magnetic properties as to have found a variety of applications including various motors, actuators and so forth. However, to further reduce the sizes and weights of electric/electronic devices and enhance the performance thereof, the R-T-B based permanent magnet needs to realize improved magnetic properties and increased corrosion resistance with the costs cut down.

In an R-T-B based permanent magnet, factors determining its remanence include the percentage of its main phase contained and the degree of magnetic alignment. To increase the main phase percentage, the composition of the R-T-B based permanent magnet may be controlled as close to the stoichiometry of an R₂T₁₄B compound as possible. Actually, however, it is difficult to decrease B among other things. From the standpoint of productivity, if the B concentration were lower than the stoichiometric value, a soft magnetic R₂Fe₁₇ phase would be nucleated in the grain boundary phase, which contributes to the coercivity of the magnet, and therefore, the coercivity would decrease significantly. For that reason, the target value of the B concentration needs to be set slightly higher than the stoichiometric value.

That is why a structure in which a B-rich phase (Nd_{1.1}Fe₄B₄) has nucleated is often formed in the grain boundary anyway in the prior art. The B-rich phase never contributes to improving the magnet performance. To the contrary, if the percentage of the B-rich phase increased, then the remanence Bᵣ would decrease. Also, it is difficult to detect a very small amount of B included, and the analysis accuracy is usually represented by an error of about ±2% with respect to the content of B. Thus, there has been no choice but to add B in an amount exceeding the stoichiometric value. Consequently, the performance of a magnet could not be further improved by reducing the concentration of B.

Meanwhile, a lot of people have proposed techniques of improving the magnetic properties by adding any of various elements to the R-T-B based permanent magnet. Among those additive elements, Ga is added to an R-T-B based sintered magnet or an R-T-B based bonded magnet (e.g., an anisotropic bonded magnet produced by an HDDR process, in particular). Ga is added in order to increase the coercivity as to a sintered magnet and to increase the coercivity and maintain anisotropy in a re-crystallization process as to a bonded magnet.

Japanese Patent Publication No. 2577373 discloses that high coercivity is achieved by adding 0.2 mass % to 13 mass % of Ga to an R-T-B based sintered magnet. Japanese Patent Publication No. 2751109 discloses that high coercivity is achieved by adding not only 0.087 mass % to 14.4 mass % of Ga but also at least one of Nb, W, V, Ta and Mo. The conventional techniques disclosed in these documents were developed for the purpose of increasing the coercivity by adding a relatively large amount of Ga.

Japanese Patent Publication No. 3255593 discloses that Ga is added to a composition R(Fe_{1-x-y-z-u}CoₓB_{y}Ga_{z}Mᵤ)_{A} such that Ga falls within a broad range of 0<z≦0.15 and also describes that significant effects are achieved by adding at least 0.087 mass % of Ga (i.e., z=0.001).

Japanese Patent Publication No. 3255344 discloses that 0.01 mass % to 0.5 mass % of Ga is added with the O (oxygen) concentration defined within the range of 0.3 mass % to 0.7 mass %. In a specific example thereof, however, at least 0.09 mass % of Ga is added. Japanese Patent Publication No. 2966342 discloses that 0.01 mass % to 0.5 mass % of Ga is added with the O (oxygen) concentration defined to be at most 0.25 mass %. In a specific example thereof, however, at least 0.08 mass % of Ga is added, when the B concentration is 1.05 mass %.

Japanese Patent Publications Nos. 3298221 and 3298219 disclose that 0.9 mass % to 1.3 mass % of B and 0.02 mass % to 0.5 mass % of Ga are both added. However, according to this technique, V must be added. Also, these publications describe no examples in which the concentration of B is less than 1.0 mass %.

Japanese Patent Publication No. 3296507 cites various additive elements, including Ga, to be added at 7 at % or less. According to this technique, however, the magnet must include not just an Nd-rich phase but also a B-rich phase as well as its essential constituent phases.

Japanese Patent Publication No. 3080275 discloses that 0.05 mass % to 1 mass % of Ga is added. But Nb must be included as one of its essential elements.

Japanese Patent Publication No. 2904571 discloses a method for producing a sintered magnet by a so-called “HDDR process” and also discloses that 0 at % to 4 at % of Ga is added. However, Ga does not work in the sintered magnet so effectively as in the HDDR process including a hydrogenation reaction.

Japanese Patent Application Laid-Open Publication No. 2002-38245 discloses an invention relating to a two-alloy method in which two alloy materials with mutually different compositions are used as a mixture, and describes that 0.01 mass % to 0.5 mass % of Ga and Al are added in combination to at least one of the two alloys. However, this publication discloses only an example in which 0.1 mass % of Ga is added.

Each of the conventional techniques mentioned above attempts to increase the coercivity either by adding a relatively large amount of Ga or by introducing Ga and any other additive element in combination. However, none of the documents cited above taught or suggested that the remanence Bᵣ could be increased by decreasing the B concentration and increasing the main phase percentage.

In order to overcome the problems described above, an object of the present invention is to provide an R-T-B based sintered magnet that has had its remanence Bᵣ increased by decreasing the percentage of a B-rich phase (R_{1.1}Fe₄B₄) and increasing its main phase percentage instead.

### DISCLOSURE OF INVENTION

An R-T-B based sintered magnet according to the present invention has a composition comprising: 27.0 mass % to 32.0 mass % of R, which is at least one of Nd, Pr, Dy and Tb and which always includes either Nd or Pr; 63.0 mass % to 72.5 mass % of T, which always includes Fe and up to 50% of which is replaceable with Co; 0.01 mass % to 0.08 mass % of Ga; and 0.85 mass % to 0.98 mass % of B.

In one preferred embodiment, the R-T-B based sintered magnet further includes at most 2.0 mass % of M, which is at least one element selected from the group consisting of Al, Si, Ti, V, Cr, Mn, Ni, Cu, Zn, Zr, Nb, Mo, In, Sn, Hf, Ta and W.

In another preferred embodiment, the R-T-B based sintered magnet includes a main phase with a tetragonal R₂T₁₄B type crystal structure, which accounts for at least 90% of the overall volume of the magnet, and substantially no R_{1.1}Fe₄B₄ phases.

In another preferred embodiment, the R-T-B based sintered magnet has an oxygen concentration of at most 0.5 mass %, a nitrogen concentration of at most 0.2 mass %, and a hydrogen concentration of at most 0.01 mass %.

An R-T-B based sintered magnet producing method according to the present invention includes the steps of: preparing a powder of an alloy that has a composition including 27.0 mass % to 32.0 mass % of R (which is at least one of Nd, Pr, Dy and Tb and which always includes either Nd or Pr), 63.0 mass % to 72.5 mass % of T (which always includes Fe and up to 50% of which is replaceable with Co), 0.01 mass % to 0.08 mass % of Ga and 0.85 mass % to 0.98 mass % of B; compacting and sintering the alloy powder, thereby making a sintered magnet; and subjecting the sintered magnet to a heat treatment at a temperature of 400° C. to 600° C.

In one preferred embodiment, the step of preparing the alloy powder includes the steps of: preparing a melt of the alloy; rapidly cooling and solidifying the melt of the alloy by a strip casting process, thereby making a rapidly solidified alloy; and pulverizing the rapidly solidified alloy.

### BRIEF DESCRIPTION OF DRAWINGS

FIG. 1 is a graph showing the B concentration dependence of the magnet performance and providing data about an example in which 0.02 mass % of Ga was added and a comparative example in which no Ga was added.

FIG. 2 is a graph showing the Ga concentration dependence of the magnet performance.

FIG. 3 shows the metallographic structure of a sintered magnet with a composition 31 Nd-bal. Fe-1 Co-0.2 Al-0.1 Cu-0.02 Ga-0.93 B, in which the photo on the left-hand side shows a backscattered electron image, while the photo on the right-hand side shows a characteristic X-ray image of B.

FIG. 4 shows the metallographic structure of a sintered magnet with a composition 31 Nd-bal. Fe-1 Co-0.2 Al-0.1 Cu-0.02 Ga-1.01 B, in which the photo on the left-hand side shows a backscattered electron image, while the photo on the right-hand side shows a characteristic X-ray image of B.

FIG. 5 shows the metallographic structure of a sintered magnet with a composition 31 Nd-bal. Fe-1 Co-0.2 Al-0.1 Cu-0.94 B, in which the photo on the left-hand side shows a backscattered electron image, while the photo on the right-hand side shows a characteristic X-ray image of B.

FIG. 6 is a graph showing magnetic properties in a situation where a portion of the rare-earth element R was replaced with a heavy rare-earth element Dy.

FIG. 7 shows how the performance of magnets made by a strip casting process and an ingot casting process depended on the B concentration.

### BEST MODE FOR CARRYING OUT THE INVENTION

The present inventors discovered that by adding as extremely small an amount as 0.01 mass % to 0.08 mass % of Ga, the nucleation of a B-rich phase (Nd_{1.1}Fe₄B₄) in the grain boundary phase could be minimized with the B concentration set equal to 0.85 mass % to 0.98 mass %, which was lower than the conventional one, and yet the production of a soft magnetic R₂Fe₁₇ phase could also be reduced significantly. The present inventors acquired the basic idea of our invention in this discovery.

According to the present invention, the nucleation of the B-rich phase in the grain boundary phase and the nucleation of the soft magnetic R₂Fe₁₇ phase are minimized by adding a very small amount of Ga. Accordingly, even if the B concentration is relatively low, excellent magnet performance is realized without decreasing the coercivity. These effects achieved by adding a very small amount of Ga were totally unknown in the prior art. In the prior art documents mentioned above, Ga is added to increase the coercivity as far as the B concentration exceeds 1.0 mass %. However, nobody but the present inventors has ever noticed that the decrease in coercivity, which used to occur when the B concentration was 0.98 mass % or less, can be minimized by adding a very small amount of Ga.

According to the present invention, even if the B concentration is defined low, the coercivity will not vary easily and there is no need to add B excessively anymore. Thus, the main phase percentage increases and the remanence Bᵣ increases, too. It is known that the presence of a B-rich phase affects the corrosion resistance negatively. In a sintered magnet according to the present invention, however, there are substantially no B-rich phases, and the corrosion resistance improves, too.

In addition, according to the present invention, since B is not added excessively, no extra R needs to be added anymore, either. Thus, no rare-earth elements R, which are precious natural resources, would be spent in vain. What is more, as the concentration of the rare-earth element R, which exhibits plenty of chemical reactivity, decreases, the corrosion resistance of the sintered magnet further increases correspondingly.

According to the present invention, since Ga is added to a much lower level than a conventional one, the performance of the magnet is improvable significantly with the amount of expensive Ga used cut down.

It is not quite clear exactly how the production of the soft magnetic phase is checked by the addition of a very small amount of Ga. However, considering the results of experiments to be described in detail later, it is believed that the post-sintering heat treatment be playing an important role there.

Hereinafter, a preferred embodiment of an R-T-B based sintered magnet according to the present invention will be described.

First, an alloy is prepared so as to have a composition including: 27.0 mass % to 32.0 mass % of R, which is at least one of Nd, Pr, Dy and Tb and which always includes either Nd or Pr; 63.0 mass % to 72.5 mass % of T, which always includes Fe and up to 50% of which is replaceable with Co; 0.01 mass % to 0.08 mass % of Ga; and 0.85 mass % to 0.98 mass % of B. Specifically, the material is melted so as to have this composition and the melt is cooled and solidified, thereby making this alloy.

The alloy may be made by a known generally used method. Among various methods of making an alloy, a strip casting process can be used more effectively than any other method. According to a strip casting process, cast flakes with a thickness of about 0.1 mm to about 5 mm, for example, can be obtained. The cast flakes thus obtained have an extremely fine columnar texture in which R-rich phases are dispersed finely and in which an R₂T₁₄B phase as a main phase has a minor-axis size of 0.1 μm to 50 μm and a major-axis size of 5 μm to approximately the thickness of the flakes themselves. Thanks to the presence of such a columnar texture, high magnetic properties are realized. Optionally, a centrifugal casting process may be adopted instead of the strip casting process. Also, an alloy with the above composition may be made by performing a reduction-diffusion process directly instead of the melting/alloying process step.

The resultant alloy is pulverized by a known method to a mean particle size of 1 μm to 10 μm. Such an alloy powder is preferably obtained by performing two types of pulverization processes, namely, a coarse pulverization process and a fine pulverization process. The coarse pulverization may be done by a hydrogen absorption and pulverization process or a mechanical grinding process using a disk mill, for example. On the other hand, the fine pulverization may be done by a mechanical grinding process using a jet mill, a ball mill or an attritor, for example.

The finely pulverized powder obtained by the pulverization processes described above is compacted into any of various shapes by a known compacting technique. The compaction is normally carried out by compressing the powder under a magnetic field. Alternatively, after the powder has been aligned with a pulse magnetic field, the powder may be compacted under an isostatic pressure or within a rubber mold.

To feed the powder more efficiently during the compaction process, make the green density more uniform, and release the compact from the mold more easily, a liquid lubricant such as a fatty acid ester or a solid lubricant such as zinc stearate is preferably added to the powder yet to be finely pulverized and/or the finely pulverized powder. The lubricant is preferably added in 0.01 to 5 parts by weight with respect to the powder of 100 parts by weight.

The green compact may be sintered by a known method. The sintering process is preferably carried out at a temperature of 1,000° C. to 1,180° C. for approximately one to six hours. The sintered compact is subjected to a predetermined heat treatment. As a result of this heat treatment, even more significant effects are achieved according to the present invention by adding a very small amount of Ga and reducing the amount of B. The heat treatment is preferably carried out at a temperature of 400° C. to 600° C. for approximately one to eight hours.

### Why This Composition is Preferred

R is an essential element for a rare-earth sintered magnet and may be at least one element selected from the group consisting of Nd, Pr, Dy and Tb. However, R preferably always includes either Nd or Pr. More preferably, R is a combination of multiple rare-earth elements such as Nd—Dy, Nd—Tb, Nd—Pr—Dy or Nd—Pr—Tb.

Among these rare-earth elements, Dy and Tb contribute effectively to increasing the coercivity, in particular. However, R may further include Ce, La or any other rare-earth element in a small amount, not just the elements mentioned above, and may also include a mishmetal or didymium. Furthermore, R does not have to be a pure element but may include some impurities, which are inevitably contained during the manufacturing process, as long as such R is readily available from an industrial point of view. The content of R is defined herein to be 27.0 mass % to 32.0 mass %. This is because if the R content were less than 27.0 mass %, then high magnetic properties (high coercivity among other things) could not be achieved. However, if the R content exceeded 32.0 mass %, then the remanence would decrease.

T always includes Fe, up to 50% of which is replaceable with Co, and may further include small amounts of other transition metal elements in addition to Fe and/or Co. Co is effective in improving temperature characteristics and corrosion resistance, in particular. Thus, a combination of at most 10 mass % of Co and Fe as the balance is usually adopted. The content of T is defined herein to be 63.0 mass % to 72.5 mass %. This is because the remanence would decrease if the T content were less than 63.0 mass % but because the coercivity would decrease if the T content exceeded 72.5 mass %.

Ga is an essential element according to the present invention. In the prior art, Ga is added relatively profusely (e.g., to 0.08 mass % or more) mainly for the purpose of increasing the coercivity. In contrast, according to the present invention, the mole fraction of B is reduced extremely close to that defined by the stoichiometry by adding Ga in a very small amount. Even so, the coercivity will not decrease, which is an effect that has never been expected by anybody in the art.

According to the present invention, the content of Ga is defined to be 0.01 mass % to 0.08 mass %. The reason is that if the Ga content were less than 0.01 mass %, then the effects described above would not be achieved and it would be difficult to do management by analysis. However, if the Ga content exceeded 0.08 mass %, then the remanence Bᵣ would drop as will be described later, which is not beneficial.

The effects of the present invention are achieved even by adding Ga by itself (i.e., without combining Ga with any other additive element). However, any other element, e.g., an element M to be described later, may be added for a different purpose (e.g., in order to further increase the coercivity).

B is also an essential element and its content can be reduced to the range of 0.85 mass % to 0.98 mass %, which is very close to that defined by the stoichiometry as described above, by adding Ga.

If the B content were less than 0.85 mass %, then a soft magnetic R₂Fe₁₇ phase would nucleate to decrease the coercivity significantly. However, if the B content were greater than 0.96 mass %, then a B-rich phase would increase too much to achieve high remanence. For these reasons, according to the present invention, the B concentration is defined so as to fall within the range of 0.85 mass % to 0.98 mass %. A more preferable B concentration range is from 0.90 mass % through 0.96 mass %. Thus, since the B concentration is reduced according to the present invention, the B-rich phase (i.e., R_{1.1}Fe₄B₄) can be substantially eliminated from the constituent phases of the sintered magnet and the volume percentage of the main phase can be increased. As a result, the remanence of the sintered magnet can be increased without decreasing the coercivity.

Optionally, a portion of B is replaceable with C. It is known that the corrosion resistance of a magnet can be increased by making such a substitution. In the magnet of the present invention, B may also be partially replaced with C but the C substitution would decrease the coercivity and is not preferred. In a normal method for producing a sintered magnet, C, contained in the magnet, does not substitute for B in the main phase but is present as a rare-earth carbide or any other impurity on the grain boundary, thus deteriorating the magnetic properties.

An element M may be added in order to increase the coercivity. The element M is at least one element selected from the group consisting of Al, Si, Ti, V, Cr, Mn, Ni, Cu, Zn, Zr, Nb, Mo, In, Sn, Hf, Ta and W. M is preferably added to at most 2.0 mass %. This is because the remanence would decrease if the M content exceeded 2.0 mass %.

According to the present invention, other inevitably contained impurities, such as Mn and Cr contained in Fe or Al, Si and Cu contained in Fe—B (ferroboron), may be included.

By processing an alloy with such a composition into a sintered magnet by the powder metallurgical method to be described later, a main phase with a tetragonal R₂T₁₄B type crystal structure accounts for 90% or more of the overall volume of the resultant sintered magnet and substantially no R_{1.1}Fe₄B₄ phase is included in its constituent phases.

Also, the sintered magnet thus obtained preferably includes at most 0.5 mass % of oxygen, at most 0.2 mass % of nitrogen and at most 0.01 mass % of hydrogen. By defining the upper limits of oxygen, nitrogen and hydrogen concentrations in this manner, the main phase percentage and the remanence Bᵣ can be both increased.

### EXAMPLES

### Example 1

Respective elements of a composition, including 31.0 mass % of Nd, 1.0 mass % of Co, 0.02 mass % of Ga, 0.93 to 1.02 mass % of B, 0.2 mass % of Al, 0.1 mass % of Cu and Fe as the balance, were melted and then solidified by a strip casting process. In this manner, alloys with mutually different B concentrations were obtained. Then, each of those alloys was pulverized by a hydrogen decrepitation process with hydrogen pressurized, kept within a vacuum at 600° C. (i.e., 873 K) for one hour, and then cooled, thereby obtaining a material coarse powder. Thereafter, this material coarse powder was finely pulverized with a gas flow pulverizer PJM (produced by Nippon Pneumatic Mfg. Co., Ltd.) within a nitrogen gas atmosphere. In every sample, the resultant fine powder had an FSSS particle size of 3.0±0.1 μm.

This fine powder was compacted under a magnetic field of 0.8 MA/m at a pressure of 196 MPa. The resultant compact had dimensions of 15 mm×20 mm×20 mm. In this compaction process, no lubricant or binder was used at all, and a transverse magnetic field press, in which the magnetic field applying direction and pressing direction were perpendicular to each other, was used.

Thereafter, this compact was sintered in a vacuum sintering furnace by keeping the compact at 800° C. (i.e., 1,073 K) for one hour and then at 1,040° C. (i.e., 1,313 K) for two hours. In this process, the in-furnace atmosphere had its Ar partial pressure kept at 300 Pa by introducing an argon (Ar) gas thereto and evacuating the furnace simultaneously. Then, the sintered body was cooled by raising the in-furnace pressure to the atmospheric pressure again with the Ar gas supplied and then letting the sintered body dissipate the heat by itself with the Ar gas still supplied thereto.

The sintered body thus obtained was machined, the magnet performance thereof was evaluated with a BH tracer, thermally treated at 500° C. (773 K) for one hour within an Ar atmosphere, and then machined again and its magnet performance was evaluated with the BH tracer one more time.

After its magnet performance had been evaluated, each sample was thermally treated at 350° C. (623 K) for one hour, thereby demagnetizing it with the heat. Then, the sample was pulverized with a steel mortar within a nitrogen atmosphere to obtain a sample to be analyzed, which was subjected to a component analysis using ICP, a carbon-nitrogen-oxygen analysis with a gas analyzer and a hydrogen analysis with TDS. All of the following composition data was obtained by analyzing the sintered magnet itself. The density was measured by an Archimedean method.

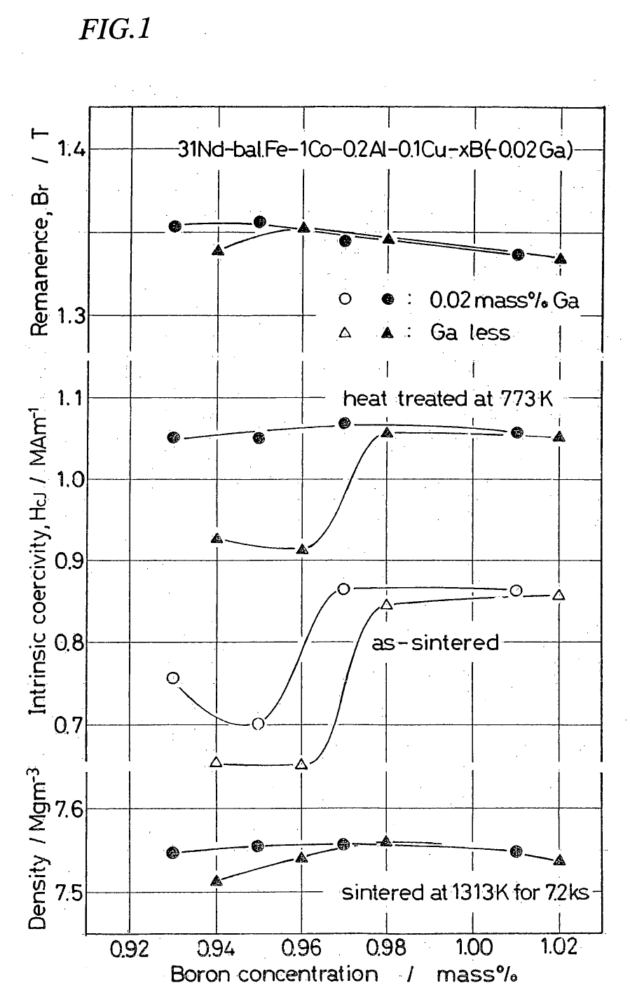

The remanence Bᵣ, coercivity H_{cJ} and sintered density of the resultant sintered body are shown in FIG. 1. The magnetic properties of the sintered body that was thermally treated at 500° C. for one hour are also shown in FIG. 1. FIG. 1 is a graph showing the B concentration dependence of the magnet performance. This graph provides data about an example in which 0.02 mass % of Ga was added and a comparative example in which no Ga was added. In FIG. 1, the open circles ◯ plot the results of measurements of the non-heat-treated sintered body (i.e., as-sintered), while the solid circles ● plot the results of measurements of the heat-treated sintered body.

When the R (Nd) content was constant, Bᵣ increased as the B concentration decreased. In this example (where ◯ represents the non-heat-treated sintered body and ● represents the heat-treated sintered body), however, even in a range where the B concentration was low, no significant decrease in coercivity was sensed after the sintered body was thermally treated. It can be seen that particularly if the B concentration was 0.98 mass % or less, the coercivity was increased significantly by subjecting the sintered body to the heat treatment.

In the comparative example (where Δ represents the non-heat-treated sintered body and ▴ represents the heat-treated sintered body) on the other hand, the coercivity dropped sharply if the B concentration was 0.98 mass % or less. This decrease in coercivity could not be lessened even if the sintered body was thermally treated.

It should be noted that every sample included 0.36 to 0.40 mass % of oxygen, 0.004 to 0.015 mass % of nitrogen, 0.04 to 0.05 mass % of carbon and at most 0.002 mass % of hydrogen.

### Example 2

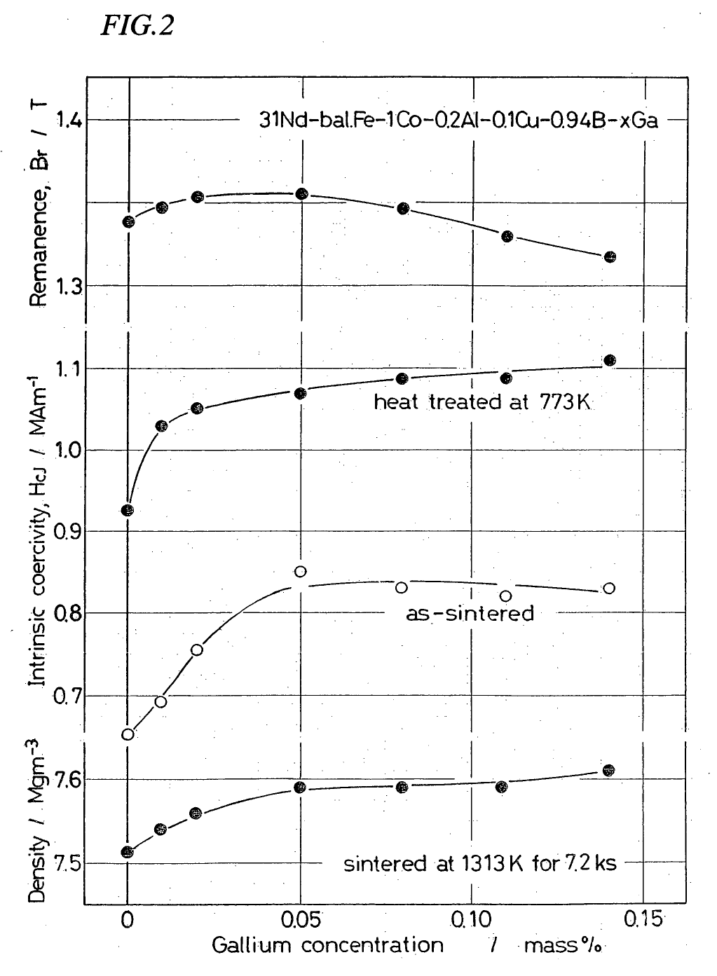

FIG. 2 is a graph showing how the magnet performance and density changed if the R content and B content were fixed at 31 mass % and 0.94 mass %, respectively, and if the Ga content was changed. As can be seen from the graph shown in FIG. 1, the B concentration of 0.94 mass % was defined within the composition range in which significant effects were achieved by adding Ga.

In this example, the samples were prepared by the same method as that adopted for the first specific example described above. As can be seen from the curve plotted in FIG. 2 with the open circles ◯ to represent the magnet performance of the non-heat-treated sintered body, the coercivity H_{cJ} increased with the addition of Ga. Also, as can be seen from the curve plotted in FIG. 2 with the solid circles ● to represent the magnet performance of the heat-treated sintered body, the coercivity H_{cJ} could be increased more efficiently even when a very small amount (0.01 mass %) of Ga was added.

Meanwhile, the remanence Bᵣ reached its peak when the Ga concentration was around 0.04 mass %. Particularly, once the Ga concentration exceeded 0.08 mass %, the sintered density increased but the remanence Bᵣ decreased to less than that of the sintered body with no Ga as shown in FIG. 2.

In view of these considerations, it can be seen that if the B concentration is defined as low as in the present invention, the Ga concentration needs to be defined to be 0.08 mass % or less. If the Ga concentration exceeded 0.08 mass % as in the prior art, then the coercivity Bᵣ would decrease, which is not beneficial.

According to the data of this example, every sample included 0.38 to 0.44 mass % of oxygen, 0.004 to 0.012 mass % of nitrogen, 0.03 to 0.05 mass % of carbon and at most 0.002 mass % of hydrogen.

### Example 3

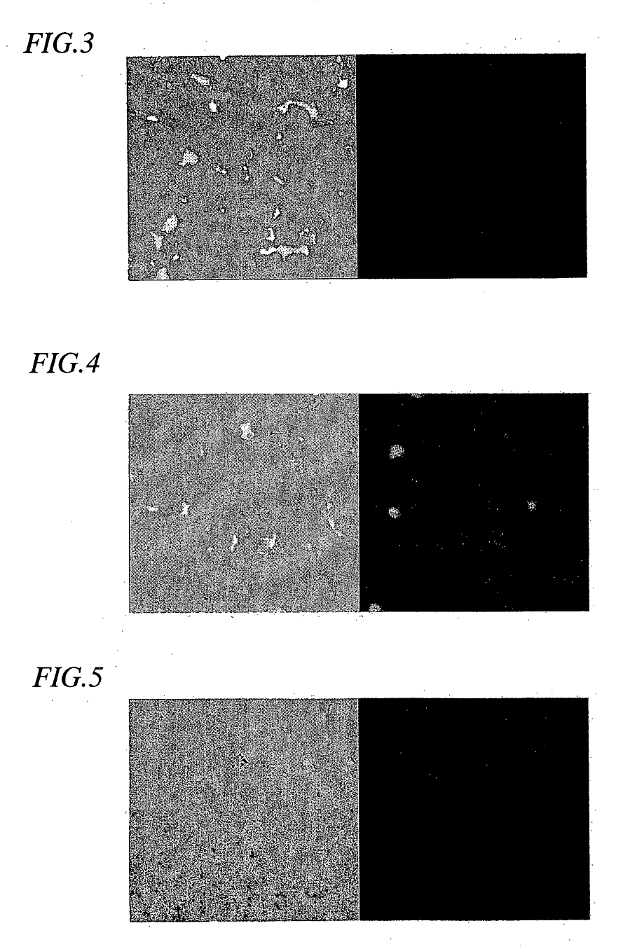

For each of the samples used in the first specific example, the thermally demagnetized magnet was machined, polished and then the metallographic structure thereof was observed. FIG. 3 shows the metallographic structure of a sintered magnet with a composition 31 Nd-bal. Fe-1 Co-0.2 Al-0.1 Cu-0.02 Ga-0.93 B. In FIG. 3, the photo on the left-hand side shows a backscattered electron image, while the photo on the right-hand side shows a characteristic X-ray image of B. It can be seen that no cluster point of B was detected, and substantially no B-rich phase was present, according to this composition.

### Comparative Example

For each of the samples used in the first specific example, the thermally demagnetized magnet was machined, polished and then the metallographic structure thereof was observed. FIG. 4 shows the metallographic structure of a sintered magnet with a composition 31 Nd-bal. Fe-1 Co-0.2 Al-0.1 Cu-0.02 Ga-1.01 B. In FIG. 4, the photo on the left-hand side shows a backscattered electron image, while the photo on the right-hand side shows a characteristic X-ray image of B. As can be seen from FIG. 4, cluster points of B were observed. That is to say, in a composition including an excessive amount of B, even if Ga was added, a B-rich phase was produced.

FIG. 5 shows the metallographic structure of a sintered magnet with a composition 31 Nd-bal. Fe-1 Co-0.2 Al-0.1 Cu-0.94 B. No Ga was added to the sintered magnet shown in FIG. 5, of which the coercivity was as low as those shown by the curves in FIG. 1.

As also can be seen from the characteristic X-ray image of B, no B-rich phases were observed. According to a three state phase diagram of Nd—Fe—B, a ferromagnetic Nd₂Fe₁₇ phase would have been produced. It should be because of the nucleation of this Nd₂Fe₁₇ phase that a sintered magnet with a composition including no additive Ga and a low B concentration exhibits decreased coercivity.

### Example 4

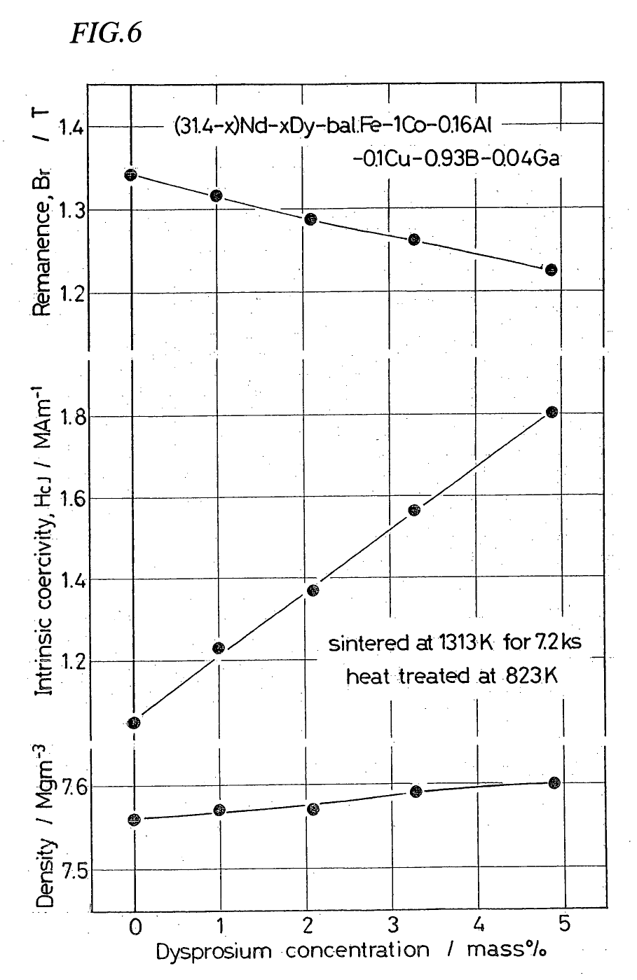

In this example, a portion of the rare-earth element R of a sample, which was prepared as in the first specific example, was replaced with Dy, a heavy rare-earth element. FIG. 6 shows how the magnetic properties depended on the substitution percentage of Dy. As can be seen from FIG. 6, even if the B concentration was as low as 0.93 mass %, high coercivity was still achieved by adding Ga.

### Example 5

The materials of respective elements were melted and cast such that the resultant sintered magnet had a composition including 31.0 mass % of Nd, 1.0 mass % of Co, 0.04 mass % of Ga, 0.2 mass % of Al, 0.1 mass % of Cu, 0.93 to 1.01 mass % of B and Fe as the balance. In this example, those materials were melted and cast by a strip casting process and by an ingot casting process. The resultant alloys had different B contents, which varied within the range of 0.93 mass % to 1.01 mass %.

These alloys with mutually different B concentrations were processed into sintered magnets by the same method as that adopted for the first specific example. In this specific example, however, when the material alloy prepared by the strip casting process was used, the sintering temperature was set to 1,040° C. (=1,313 K). On the other hand, when the material alloy prepared by the ingot casting process was used, the sintering temperature was set to 1,070° C. (=1,343 K). In each of these two cases, the sintering temperature was maintained for two hours.

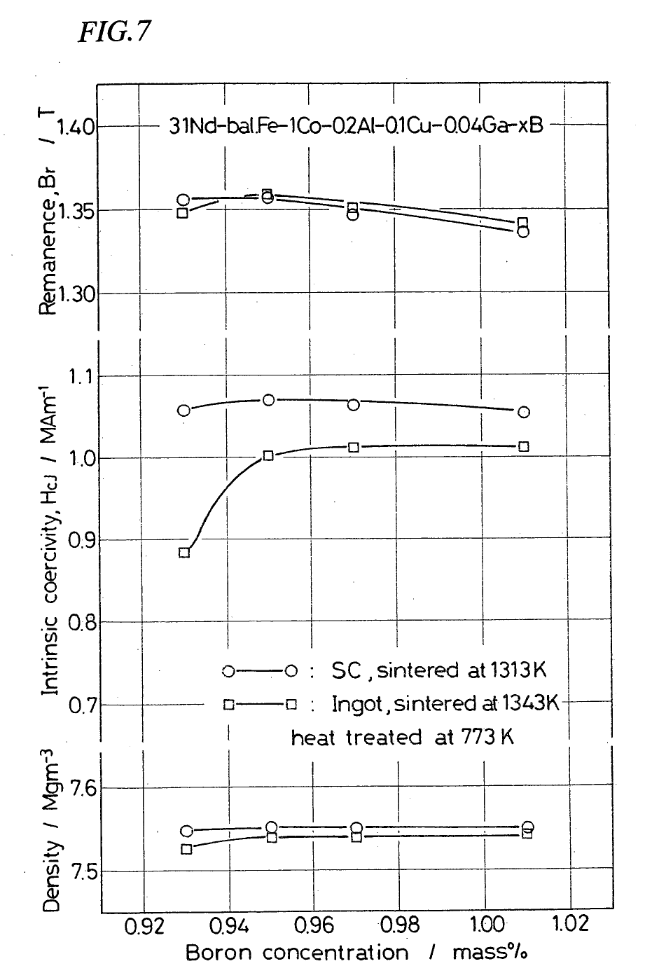

The magnetic properties of the resultant magnet were evaluated as in the first specific example described above. FIG. 7 shows how the magnetic properties of the magnet depended on the B concentration after the sintered body was thermally treated at 500° C. (=773 K) for one hour. In FIG. 7, the open circles ◯ represent data about the strip-cast alloy while the open squares □ represent data about the ingot cast alloy.

As can be seen from FIG. 7, no matter which of the two casting processes was adopted, even if the B concentration was lower than the situation where no Ga was added as plotted with the solid triangles ▴ as a comparative example in FIG. 1, no decrease in coercivity was sensed. Thus, it can be seen that the addition of Ga was effective in reducing the B concentration. It can also be seen that the strip-cast alloy achieved superior effects as compared with the ingot-cast alloy.

In this specific example, every sample included 0.38 to 0.41 mass % of oxygen, 0.012 to 0.020 mass % of nitrogen, 0.04 to 0.06 mass % of carbon and at most 0.002 mass % of hydrogen.

### INDUSTRIAL APPLICABILITY

According to the present invention, even though the B concentration is reduced, a high-coercivity sintered magnet, including substantially no B-rich phases (R_{1.1}Fe₄B₄), can still be provided with the production of a soft magnetic phase minimized. Since B is designated as one of controlled substances according to the PRTR law, it is very beneficial in itself to be able to cut down the use of B.

In addition, according to the composition of the present invention, after the heat treatment, the coercivity hardly changes (i.e., decreases) with the B concentration. Thus, the control reference level of the B concentration can be relaxed and a sintered magnet of quality can be provided with good reproducibility.

Although Ga required in the present invention is an expensive metal, the effects of the present invention described above are achieved by adding an extremely small amount of Ga compared with the conventional technique. Thus, the overall cost never increases. Furthermore, as the B-rich phase can be eliminated, the amount of R required can also be reduced, thus cutting down the cost for this reason also. What is more, since the B-rich phase can be eliminated and the R content can be reduced, the corrosion resistance increases as described above.

1. An R-T-B based sintered magnet having a composition comprising:
27.0 mass % to 32.0 mass % of R, which is at least one of Nd, Pr, Dy and Tb and which always includes either Nd or Pr;
63.0 mass % to 72.5 mass % of T, which always includes Fe and up to 50% of which is replaceable with Co;
0.01 mass % to 0.08 mass % of Ga; and
0.85 mass % to 0.98 mass % of B,
wherein the magnet comprises a main phase with a tetragonal R₂T₁₄B type crystal structure, which accounts for at least 90% of the overall volume of the magnet, but includes substantially no R_{1.1}Fe₄B₄ phases.

2. The R-T-B based sintered magnet of claim 1, further comprising at most 2.0 mass % of M, which is at least one element selected from the group consisting of Al, Si, Ti, V, Cr, Mn, Ni, Cu, Zn, Zr, Nb, Mo, In, Sn, Hf, Ta and W.

3. (canceled)

4. The R-T-B based sintered magnet of claim 1 or 2, having an oxygen concentration of at most 0.5 mass %, a nitrogen concentration of at most 0.2 mass %, and a hydrogen concentration of at most 0.01 mass %.

5. A method for producing an R-T-B based sintered magnet, the method comprising the steps of:
preparing a powder of an alloy that has a composition comprising 27.0 mass % to 32.0 mass % of R (which is at least one of Nd, Pr, Dy and Tb and which always includes either Nd or Pr), 63.0 mass % to 72.5 mass % of T (which always includes Fe and up to 50% of which is replaceable with Co), 0.01 mass % to 0.08 mass % of Ga and 0.85 mass % to 0.98 mass % of B;
compacting and sintering the alloy powder, thereby making a sintered magnet; and
subjecting the sintered magnet to a heat treatment at a temperature of 400° C. to 600° C.

6. The method of claim 5, wherein the step of preparing the alloy powder includes the steps of:
preparing a melt of the alloy;
rapidly cooling and solidifying the melt of the alloy by a strip casting process, thereby making a rapidly solidified alloy; and
pulverizing the rapidly solidified alloy.
